(19) United States
(12) Patent Application Publication
(10) Pub. No.: US 2017/0258687 A1
(43) Pub. Date: Sep. 14, 2017

(54) Teat

(71) Applicant: MAPA GmbH, Zeven (DE)

(72) Inventor: Eckhard ITZEK, Nartum (DE)

(73) Assignee: MAPA GmbH, Zeven (DE)

(21) Appl. No.: 15/510,155

(22) PCT Filed: Sep. 11, 2015
(86) PCT No.: PCT/EP2015/070823

§ 371 Date: Mar. 9, 2017

(30) Foreign Application Priority Data
Sep. 11, 2014 (DE) 10 2014 113 122.3

(51) Int. Cl. A61J 11/02; A61J 9/00; A61J 11/04

(52) U.S. Cl. CPC A61J 11/02; A61J 11/045; A61J 9/00

(57) ABSTRACT

A teat, in particular for infants and small children, having a hollow nipple with at least one through-hole for liquid nutrition, which is connected at the bottom to a substantially annular-disc-shaped nipple flange, which serves to be fastened to the mouth of a vessel by means of a fastening ring with an annular-disc-shaped ring flange overlapping the nipple flange for pressing the bottom side of the nipple flange flat against the front-side edge of the mouth and at least one recess extending in the radial direction of the nipple flange on the top side of the nipple flange so that a ring flange of a fastening ring pressing against the top side of the nipple flange is spaced from the top side of the floor of the recess during the fastening of the teat on the mouth of a vessel, and the nipple flange is sufficiently flexible at least in the area of the recess so that the floor arches up and air from outside flows back into the vessel under the arched floor of the recess in the radial direction when the teat is fastened on the mouth of a vessel and negative pressure is created in the vessel when the nipple is sucked on.

The invention relates to a teat, especially for infants and small children. The teats can be designed in particular as a feeding teat or as a drinking aid (e.g. feeding spout or drinking spout) according to European standard EN 14350-1.

Teats are used to administer milk and other liquid nutrition, especially to infants and small children. Teats have a hollow nipple with a through-hole for liquid nutrition. The nipple is connected at the bottom as one piece to an annular-disc-shaped nipple flange, which serves to be fastened to the mouth of a vessel. The vessel is in particular a drinking bottle (e.g. feeding bottle), drinking cup or food bag. A fastening ring, which has a cylindrical cover with fastening means for fastening on fastening means of the vessel, is used for fastening on the vessel. Frequently, the fastening means are threads on the inner circumference of the cover and on the outer circumference of the vessel. Furthermore, the fastening ring has an inward-projecting, annular-disc-shaped ring flange that overlaps the nipple flange and presses against the front-side edge of the mouth of the vessel. Feeding teats are usually made entirely of soft elastic material. Frequently, drinking aids and drinking spouts are also made of soft elastic material. However, drinking aids are also made of hard material or of a combination of hard and soft materials. For example, drinking aids made of a hard material with a valve insert made of soft elastic material are known. In particular, there are soft elastic valve inserts, which are clamped in a sealing manner on the edge between the mouth of the vessel and the drinking aid.

When the nipple is sucked on, negative pressure is created in the vessel, which makes it harder to remove the liquid. A soft elastic teat can collapse from the negative pressure, causing the nipple to slip into the vessel. To prevent this, teats have a ventilation valve. The ventilation valve opens when a certain negative pressure predominates in the vessel. Pressure is hereby equalized with the surrounding area.

DE 137 39 911 C5 describes a teat and the fastening of the teat by means of a threaded ring to a bottle. The ventilation valve is designed as a slit valve in a recess on one side of the nipple. The slit valve is incorporated into the teat in a complex method step by means of a knife. It is also disadvantageous that the sealing lips delimited by the slit only rest against each other with light pressure so that the slit valve can open even with slight negative pressure that is lower than the negative pressure created by a child during natural breast-feeding.

Furthermore, teats are known with a ventilation valve between the nipple flange and threaded ring. DE 10 2005 006 768 A1 discloses such a teat with a nipple flange, which carries an annular elevation on the top side, which engages in a groove in a circumferential bottom base surface of the threaded ring. The nipple flange has a valve opening that tapers in the direction of the ring flange of the threaded ring and has a large opening cross-section in the elevation. On the outside, the nipple has a recess that extends to the nipple flange and forms a ventilation channel. The outer edge area of the nipple flange is clamped between the front-side edge of the mouth and the ring flange outside the valve opening. If negative pressure predominates in the bottle, the inner part of the nipple flange can move downward, causing the elevation to move away from the base of the groove. Consequently, the pressure can be equalized through the ventilation channel, the gap between the ring flange and nipple flange, and the valve opening. The production and the cleaning of the teat are complex. An axial force acting on the nipple can also open the ventilation valve, whereby the buildup of the negative pressure in the bottle is prevented.

A similar construction is known from US 2007/0102388 A1.

Teats with lip valves on the bottom side of a nipple flange are known from US 2005/0252875 A1, WO 2006/103379 A1, DE 202 04 357 U1 and US 2003/0106872 A1. These teats are produced in an injection molding procedure. For production reasons, the sealing lips lie against each other without initial tension so that they can be easily opened by a negative pressure. The pressure is equalized when the lip valve is opened through a gap between the top side of the nipple flange and the bottom side of the ring flange. When liquid lies against the side surfaces of the ventilation valve, they are pressed together and the liquid is prevented from exiting. The two last-cited documents describe teats in which the lip valve is integrated in the wall of the nipple flange.

GB 797 784A and U.S. Pat. No. 2,762,520A describe teats with a nipple flange, the top side of which rests in a sealing manner on the ring flange of the fastening ring and has an annular groove. Several ventilation holes, which are connected with the bottom side of the ring flange and communicate with the inside of the bottle, terminate in the annular groove. Only the outer edge of the nipple flange is clamped between the ring flange and the front-side edge of the mouth. When the nipple is sucked on, the inner part of the nipple flange that is not clamped between the ring flange and mouth is bent away from the ring flange by the negative pressure in the bottle so that the pressure is equalized through the ventilation holes. The production and cleaning of the teat are complex.

U.S. Pat. No. 2,811,270 describes a nipple flange with vertical ventilation holes, which rests on top in a sealing manner against the ring flange of the fastening ring. The ventilation holes open on the top in an annular groove on the bottom side of the ring flange and on the bottom in the interior of the bottle. The nipple flange is only clamped between the ring flange and the mouth on the outer edge. When the nipple is sucked on, the inner part of the nipple flange bends away from the ring flange and ambient air flows through the ventilation holes. Production and cleaning of this teat are also complex.

DE 10 2011 013 080 A1 describes a teat with a contact area protruding downwards or upwards from a nipple flange or outwards into the space for the placement of the ring flange from a nipple above the nipple flange. The teat also has a lip valve that is open when the nipple flange is not fastened on a bottle. The lip valve is arranged in a deformation area next to the contact area so that, in the case of the fastening of the nipple flange by means of a fastening ring on a bottle, the deformation of the nipple teat and/or nipple spout caused by the pressing of the fastening ring on the contact area closes the lip valve. Due to the lip valve, production and cleaning of this teat are still comparatively complex.

Against this background, the object of the invention is to create a teat with a ventilation valve, the production and cleaning of which is easier.

The object is solved by the inventive teat.

The teat according to the invention, especially for infants and small children, has a hollow nipple with at least one through-hole for liquid nutrition,

which is connected at the bottom to a substantially annular-disc-shaped nipple flange, which serves to be fastened to the mouth of a vessel by means of a fastening ring with an annular-disc-shaped ring flange overlapping the nipple flange for pressing the bottom side of the nipple flange flat against the front-side edge of the mouth and

at least one recess extending in the radial direction of the nipple flange on the top side of the nipple flange so that a ring flange of a fastening ring pressing against the top side of the nipple flange is spaced from the top side of the floor of the recess during the fastening of the teat on the mouth of a vessel, and the nipple flange is sufficiently flexible at least in the area of the recess so that the floor arches up and air from outside flows back into the vessel under the arched floor of the recess in the radial direction when the teat is fastened on the mouth of a vessel and a certain negative pressure is created in the vessel when the nipple is sucked on.

The teat according to the invention has a recess on the top side of the nipple flange. In the case of the fastening of the teat by means of a fastening ring, it presses with its ring flange against the top side of the nipple flange and presses the bottom side thereof in a sealing manner against the front-side edge of the mouth. The ring flange outside of the recess thereby presses against the top side of the nipple flange and is hereby held at a distance from the top side of the floor of the recess. Thus, there is free space between the ring flange and the floor of the recess, into which the floor can arch up. The floor is sufficiently flexible for this. The floor arches up when the negative pressure in the vessel is high enough. The different pressures acting on the nipple flange during sucking cause the arching of the floor. Under the arched floor, air from the surrounding area can flow back into the vessel from outside, whereby the pressure is equalized with the surroundings. A new type of ventilation valve is realized in this manner. The recess in the nipple flange is easier to establish than the ventilation valves of conventional teats. It is also advantageous that the recess is easy to reach from outside and can be easily cleaned. Moreover, in the case of the teat according to the invention, a precise determination of the opening pressure is possible, in which air from the surrounding area flows back into the vessel.

Drinking comfort is improved through the opening of the ventilation valve when a certain negative pressure has been reached in the vessel (e.g. 20 to 30 mbar). The momentum, with which the fastening ring is pulled, only has a slight impact on the opening pressure. The teat promotes more constant drinking, which is not disturbed by the gradual buildup of negative pressure in the vessel.

Ambient air can flow back to the recess between the fastening ring and the vessel or the fastening ring and the nipple. If the fastening ring is designed as a threaded ring, the ambient air can flow to the recess along the screw thread. According to one embodiment, the teat is a feeding teat or a drinking aid (e.g. feeding spout or drinking spout). According to one embodiment, the vessel is a drinking bottle (e.g. feeding bottle), a drinking cup or food bag. According to one embodiment, the fastening ring is a threaded ring to be screwed onto the thread of the vessel, a snap ring to be snapped onto a snap projection of the vessel or a bayonet locking ring to be fastened on a bayonet lock of the vessel.

According to a preferred embodiment, the recess is a groove extending in the radial direction of the nipple flange.

According to one embodiment, the floor of the recess has a downwards curvature, which is pressed flat when the nipple flange is mounted on the vessel by means of a fastening ring so that the floor of the recess rests against the edge of the mouth under elastic initial tension. In this embodiment, the teat is produced such that the floor of the recess arches downwards slightly. During the pressing of the nipple flange against the edge of the mouth, the floor is pressed flat and lies against the edge of the mouth under increased initial tension, whereby the opening pressure during which the ventilation valve opens is impacted. It is hereby possible to optimize the opening pressure, in particular so that it matches the negative pressure created by a child during natural breast-feeding.

According to a further embodiment, the negative pressure at which the floor arches up ranges from 15 to 100 mbar, preferably 20 to 50 mbar.

According to a further embodiment, the recess extends over the entire area in the radial direction of the nipple teat, with which the nipple flange rests on the front-side edge of the mouth. In this embodiment, a particularly large amount of air from the surrounding area can flow back into the vessel when the ventilation valve opens.

According to a further embodiment, the recess emanates from the outer edge of the nipple flange. According to a further embodiment, the recess extends in the radial direction over at least half of the nipple flange. The production of the teat can hereby be simplified and it can be ensured that the recess is arranged above the front-side edge of the mouth, even if the nipple flange is not fixed exactly concentrically on the edge of the mouth. Moreover, this embodiment benefits the return flow of ambient air to the recess between the nipple and the fastening ring.

According to one embodiment, the nipple flange has, at least on the bottom side of the floor of the recess, bars and/or a surface texture and/or at least one lower recess, which is surrounded on all sides by non-recessed areas of the bottom side of the nipple flange, for easier detachment from the mouth of the bottle. According to a preferred embodiment, the bars are aligned radially. The opening of the ventilation valve is improved at a certain negative pressure by the bars or respectively the surface texture or respectively the lower recess. The bars or respectively the surface texture or respectively the lower recess enable an opening of the ventilation valve at a certain negative pressure even when the nipple flange sticks to the edge of the mouth due to beverage residue.

According to a further embodiment, the bars and/or the surface texture and/or the lower recess are only present on the bottom side of the floor of the recess.

According to a further embodiment, the teat has several lower recesses arranged behind each other in the radial direction and/or several lower recesses arranged next to each other in the circumferential direction. It is hereby ensured that, regardless of the seating of the nipple flange on the edge of the mouth of the vessel, at least one of the lower recesses is always arranged on the edge of the mouth of the bottle in a suitable position for the ventilation.

The lower recess can have different geometries. It is for example rectangular, oval or circular.

The expansion of the lower recess in the radial direction and/or in the circumferential direction is preferably less than the expansion of the recess in the corresponding direction. The expansion of the lower recess in the radial direction and/or in the circumferential direction is preferably at most half the expansion of the recess in the corresponding direction.

The lower recess is designed such that its expansion in the radial direction of the nipple flange is less than the width of the edge of the mouth of the bottle. It is furthermore preferable for the lower recess to be arranged on the nipple flange so that during the attachment of the nipple flange to the edge of the mouth of the bottle the lower recess partially covers the inner rim of the edge of the mouth. When there is negative pressure in the bottle, this causes the nipple flange to rise up slightly from the edge of the mouth further outside radially in the area of the recess so that ambient air can flow back into the bottle through the gap between the nipple flange and the edge of the mouth and through the lower recess.

According to a further embodiment, the nipple has a constriction above the nipple flange. The constriction allows the fastening ring to be undetachably preinstalled on the teat and thereby makes handling easier. Moreover, the nipple at least partially covers the fastening ring which creates a large, soft contact area for the mouth and chin of a child.

According to a further embodiment, the floor of the recess is made from a soft elastic material. It is hereby achieved that the floor arches up when there is negative pressure in the vessel and otherwise lies in a sealing manner on the edge of the mouth. According to a preferred embodiment, the entire nipple flange is made of soft elastic material. This is advantageous for the production of the teat and benefits a sealing placement of the nipple flange on the edge of the mouth of the vessel. According to a preferred embodiment, the entire teat is made of soft elastic material. This simplifies the production and is preferably the case when the teat is designed as a feeding spout or as a drinking aid. But in particular when designed as a drinking aid, the nipple flange can also be made partially and the nipple can be made entirely or partially of a hard material, in particular a hard elastic plastic.

According to a further embodiment, the teat is made entirely or partially of silicone or a thermoplastic elastomer or another plastic that can be injection molded or latex. Silicone, thermoplastic elastomer and latex are preferably used as soft elastic materials for the floor, the nipple flange or the entire teat.

According to a further embodiment, the teat is injection-molded or produced in a combined immersion-casting process.

According to a further embodiment, the nipple flange has an inner diameter of 20 to 65 mm and/or an outer diameter of 30 to 70 mm and/or a height of 0.5 to 3 mm. The teat is suitable in particular for wide-mouth bottles, for normal bottles, for feeding bottles, drinking cups or food bags.

The opening pressure at which the ventilation valve opens is determined in particular by the depth of the recess in the nipple flange, the dimensions of the recess in the radial direction and in the circumferential direction of the nipple flange and by the thickness of the floor wall. According to a preferred embodiment, the recess has a depth in the nipple flange of 0.5 to 2.5 mm and/or a length in the radial direction of the nipple flange of 2 to 10 mm and/or a width in the circumferential direction of the nipple flange of 5 to 15 mm and/or the floor of the recess has a thickness of 0.5 to 1.5 mm.

Finally, one embodiment of the invention relates to a drinking vessel with a teat, which is mounted on a vessel by means of a fastening ring, wherein the fastening ring has fastening means and the vessel has further fastening means that are interconnected in order to fasten the teat on the vessel, presses a ring flange of the fastening ring outside of the recess against the top side of the nipple flange and presses the nipple flange with the bottom side against the edge of the mouth of the vessel, wherein the recess is designed so that negative pressure in the vessel causes the floor of the recess to arch up and air flows back into the vessel from outside in the radial direction.

According to one embodiment of the drinking vessel, the expansion of the lower recess in the radial direction is less than the width of the edge of the mouth of the vessel and/or the distance between two lower recesses located consecutively in the radial direction is less than the width of the edge of the mouth of the vessel. In this embodiment, it is achieved that the nipple flange rests in a sealing manner on the edge of the mouth in the area of the lower recess even when there is no negative pressure in the bottle. In contrast, when there is negative pressure in the bottle, the nipple flange rises up slightly away from the edge of the mouth further outside radially so that ambient air can flow back in the gap between the nipple flange and the edge of the mouth and back into the bottle through the lower recess via the inner rim of the edge of the mouth. Furthermore, it is achieved that the distance between two lower recesses located consecutively in the radial direction is less than the width of the edge of the mouth of the vessel, that a lower recess is always partially arranged above the edge of the mouth. As a result, the mouth is sealed in the vessel when there is no negative pressure and ambient air can flow back into the vessel through the gap between the nipple flange and the mouth as well as the lower recess as long as there is negative pressure there.

According to one embodiment, the nipple flange protrudes radially inwards and/or outwards over the front-side edge of the mouth of the vessel.

The invention will be explained in greater detail below based on the accompanying drawings of exemplary embodiments. The drawings show:

FIG. 1 a teat in a perspective view diagonally from the top and from the side;

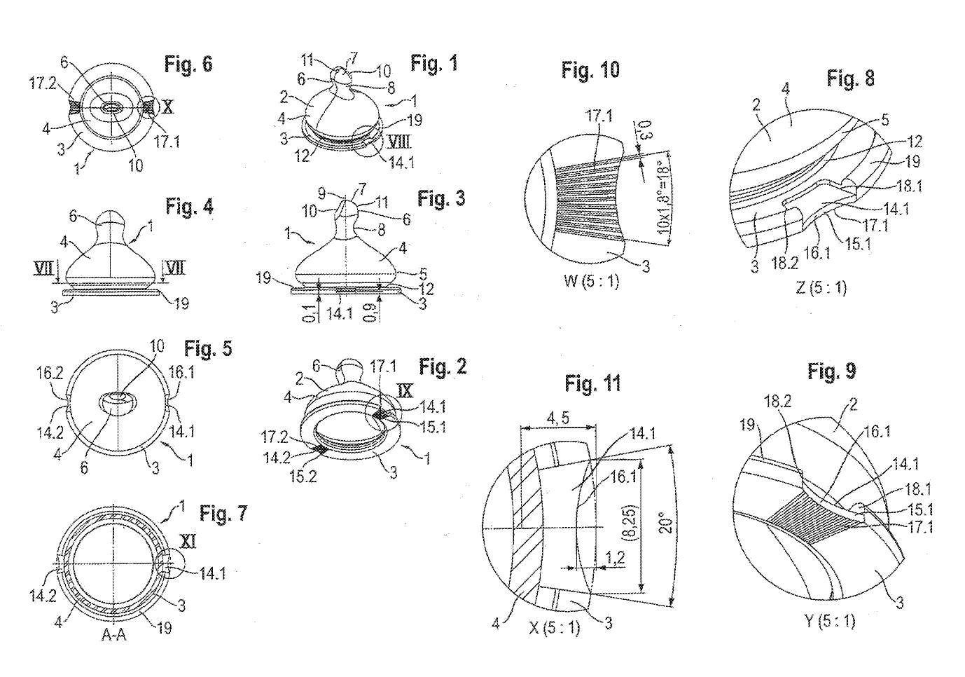

FIG. 2 the teat in a perspective view diagonally from below and from the opposite side;

FIG. 3 the teat in a view from the right side;

FIG. 4 the teat in a front view;

FIG. 5 the teat in a view from the top;

FIG. 6 the teat in a view from the bottom;

FIG. 7 the teat in a cut along line VII-VII of FIG. 4;

FIG. 8 enlarged detail VIII of FIG. 1;

FIG. 9 enlarged detail IX of FIG. 2;

FIG. 10 enlarged detail X of FIG. 6;

FIG. 11 enlarged detail XI of FIG. 7;

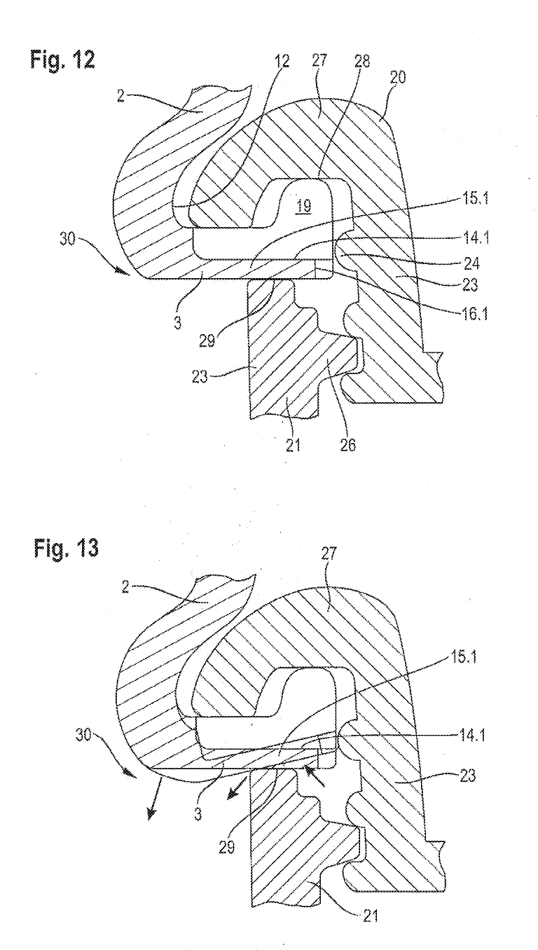

FIG. 12 the teat fastened on the mouth of a vessel by means of a fastening ring in a roughly schematic partial section;

FIG. 13 the arched-up floor of the teat in a perspective partial view;

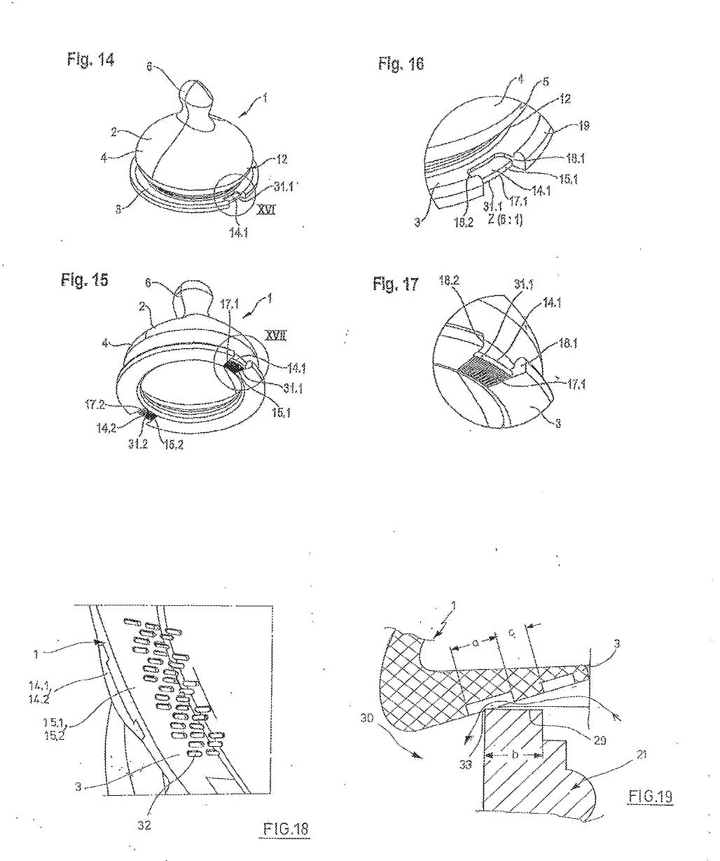

FIG. 14 an alternative teat in a perspective view diagonally from above and from the side;

FIG. 15 the teat in a perspective view diagonally from below and from the opposite side;

FIG. 16 enlarged detail XVI FIG. 14;

FIG. 17 enlarged detail XVII of FIG. 15;

FIG. 18 an alternative teat in a perspective view of the nipple flange diagonally from below and from the side;

FIG. 19 the same teat on the mouth of a vessel in the case of the presence of negative pressure in a vertical partial cut.

In the present application, the terms “top” and “bottom” refer to an arrangement of the teat with the nipple above the nipple flange in the case of the horizontal alignment of the nipple teat. Furthermore, the vessel is arranged below the teat.

The teat 1 has a nipple 2, which is connected on the bottom with a circular annular nipple flange 3. The nipple 2 has a bellows-like nipple spout 4 that tapers upward from a large diameter 5. At the top, the nipple spout 4 bears a nipple 6 that has a nipple neck 7 and a nipple head 8. On one side, the nipple head 8 is provided with a chamfer 10 at an angle to the central axis 9 of the nipple flange 3. On the opposite side, it has at least one passage opening 11 in the form of a drinking hole for liquid food.

At the bottom, the nipple spout 4 has a constriction 12. At the bottom end of the constriction 12, the nipple spout 4 is connected to the nipple flange 3 projecting radially outward that concentrically surrounds the central axis 9.

The nipple flange 3 is mainly flat but has respectively a groove-like recess 14.1, 14.2 on the top side at two diametrically opposing spots. Each recess 14.1, 14.2 has a floor 15.1, 15.2, which has e.g. a thickness of 0.9 mm.

The generally annular-disc-shaped nipple flange 3 has respectively an impression 16.1, 16.2 on the outer edge next to the recesses 14.1, 14.2.

The floor 15.1, 15.2 of each recess is respectively provided on the bottom side with a series of radially extending bars 17.1, 17.2, e.g. ten bars 17.1, 17.2 are present below each floor 15.1, 15.2, wherein an angular distance of 1.8° is present between neighboring bars. For example, each bar 17.1, 17.2 has a width of 0.3 mm and a height of 0.1 mm.

Each recess 14.1, 14.2 extends in the radial direction from the outer edge of the nipple flange 3 via at least half of the nipple flange 3, preferably up until shortly before or up to the inner edge of the nipple flange 3. The length of each recess 14.1, 14.2 in the radial direction is e.g. 4.5 mm (3.3 mm at the narrowest point of the impression) and e.g. 8.25 mm on the outer periphery in the circumferential direction. Each recess 14.1, 14.2 is delimited by edges 18.1, 18.2 extending radially with respect to the nipple flange 3, wherein the opening angle between the edges is 20°.

Furthermore, the nipple flange 2 on the outer edge has a circumferential, vertically protruding edge bulge 19. The edge bulge 19 is interrupted by the recesses 14.1, 14.2.

The thickness of the nipple flange 3 is e.g. 15 mm within the edge bulge 19. The thickness of the floor 15.1, 15.2 is e.g. 0.9 mm in the area between the radial ribs 17. The height of each rib is e.g. 0.1 mm.

In the example, the teat 1 is a feeding spout. It is made e.g. of silicone, thermoplastic elastomer or latex.

According to FIG. 12, the teat 1 is fastened on a vessel 21 by means of a fastening ring 20. On the inner perimeter of its approximately cylindrical cover 23, the fastening ring 20 has an internal thread 24, and on the outer perimeter of its neck 25, the vessel 21 has an outer thread 26 so that the fastening ring 20 can be screwed onto the vessel 21. On the upper edge, the fastening ring 20 has an inwards protruding ring flange 27, which has a circumferential annular groove 28 on the inner perimeter.

The ring flange 27 engages in the constriction 12 of the teat 1. The edge bulge 19 engages in the annular groove 28.

The ring flange 27 presses against the top side of the nipple flange 3 and hereby presses it with the bottom side against the flat front-side edge 29 of a mouth 30 of the vessel 21. The ring flange 27 presses against the top side of the nipple flange 3 next to the recesses 14.1, 14.2. It does not press against the floor 15.1, 15.2 of the recesses 14.1, 14.2.

The nipple flange 3 is measured such that it protrudes with the floor 15.1, 15.2 of the recesses 14.1, 14.2 radially outward and radially inward over the front-side edge 29 of the mouth 30.

In the radial direction, the cover of the nipple flange 3 with the front-side edge 29 of the mouth 30 is e.g. 1 mm.

When the teat 1 is sucked on and negative pressure is hereby created in the vessel 21, the floor 15.1, 15.2 arches up, as also shown in FIG. 13 by finer lines. In this state, ambient air can flow from outside in the direction of the arrows, whereby ventilation is achieved.

The impressions 16.1, 16.2 prevent the internal thread 24 of the fastening ring 20 from colliding with the outer edge of the floor 15.1, 15.2 and prevents it from arching up.

The exemplary embodiment from FIGS. 14 to 17 differs from exemplary embodiment described above in that the nipple flange 2 on the recesses 14.1, 14.2 has rectangular spaces 31.1, 31.2 on the outer edge instead of impressions 16.1, 16.2. The spaces 31.1, 31.2 also benefit a free arching up of the floor 15.1, 15.2 when negative pressure prevails in the vessel 21.

The exemplary embodiment from FIGS. 18 and 19 mainly differs from the exemplary embodiment from FIGS. 1 to 13 in that the teat 1 on the bottom side of the floor 15.1, 15.2 of each recess 14.1, 14.2 has several lower recesses 32, each of which are surrounding on all sides by a non-recessed area 32 of the nipple flange 3. Thus, neighboring lower recesses 32 are separated from each other by a non-recessed area on the bottom side of the nipple flange 3. Furthermore, several lower recesses 32 are arranged behind each other in the radial direction and several lower recesses 32 are arranged next to each other in the circumferential direction. The arrangement of the lower recesses 32 is limited to the area of the floor 15.1, 15.2 of the recesses 14.1, 14.2. Each lower recess 32 is considerably smaller than the recess 32. In the example, the lower recesses 32 each have an almost rectangular shape, wherein the main axis of each rectangular geometry extends in the radial direction.

According to FIG. 19, the length a of each lower recess 32 in the radial direction is less than the width b of the edge 29 of the mouth 30 of the vessel 21. Furthermore, the distance c between the lower recesses 32 neighboring in the radial direction is less than the width b of the edge 29 of the mouth 30 of the vessel 21.

As shown in FIG. 19, when the nipple flange 3 is arranged on the mouth 30 of a vessel 21, a recess 32 is always arranged such that it covers the inner rim 33 of the edge 29 of the mouth 30 of the vessel 21. If there is negative pressure in the vessel, the nipple flange 3 rises up away from the edge 29 of the mouth 30 further outside radially and no longer seals there. As a result, ambient air between the nipple flange 3 and the edge 29 of the mouth 30 can flow radially inwards and finally makes its way through the lower recess 32, which covers the inner rim 33 of the edge 29 of the mouth 30, into the vessel 21, in order to equalize the pressure. Once the negative pressure in the vessel 21 has dissipated, the nipple flange 3 with the areas between the lower recesses 32 lies on the edge 29 of the mouth 30. A sealing line proceeding in the circumferential direction in an uninterrupted manner between and through the neighboring lower recesses 32 is also hereby created below the recess 14.1, 14.2 so that ambient air cannot flow back in.

1. A teat, in particular for infants and small children, comprising:
a hollow nipple (2) with at least one through-hole (11) for liquid nutrition,
which is connected at the bottom to a substantially annular-disc-shaped nipple flange (3), which serves to be fastened to the mouth (30) of a vessel (21) by means of a fastening ring (20) with an annular-disc-shaped ring flange (27) overlapping the nipple flange (2) for pressing the bottom side of the nipple flange (3) flat against the front-side edge (29) of the mouth (30) and
at least one recess (14.1, 14.2) extending in the radial direction of the nipple flange (3) on the top side of the nipple flange (3) so that a ring flange (27) of a fastening ring (20) pressing against the top side of the nipple flange (3) is spaced from the top side of the floor (15.1, 15.2) of the recess (14.1, 14.2) during the fastening of the teat (1) on the mouth of a vessel (21), and the nipple flange (3) is sufficiently flexible at least in the area of the recess (14.1, 14.2) so that the floor (15.1, 15.2) arches up and air from outside flows back into the vessel (21) under the arched floor (15.1, 15.2) of the recess (14.1, 14.2) in the radial direction when the teat (1) is fastened on the mouth of a vessel (21) and a certain negative pressure is created in the vessel (21) when the nipple (2) is sucked on.

2. The teat according to claim 1, in which the recess (14.1, 14.2) is a groove extending in the radial direction of the nipple flange (3).

3. The teat according to claim 1, in which the floor (15.1, 15.2) of the recess (14.1, 14.2) has a downwards curvature, which is pressed flat when the nipple flange (2) is mounted on the vessel (21) by means of a fastening ring (20) so that the floor (15.1, 15.2) of the recess (14.1, 14.2) rests against the edge (29) of the mouth (30) under elastic initial tension.

4. The teat according to claim 1, in which the negative pressure at which the floor (15.1, 15.2) arches up, is settled in the range of 25 to 100 millibar, preferably approximately 20 to 30 millibar.

5. The teat according to claim 1, to in which the recess (14.1, 14.2) extends in the radial direction of the nipple flange (3) over the entire area with which the nipple flange (3) lies against the front-side edge of the mouth (30).

6. The teat according to claim 5, in which the recess (14.1, 14.2) extends in the radial direction over at least half of the nipple flange (3).

7. The teat according to claim 1, in which the nipple flange (2) has, at least on the bottom side of the floor (15.1, 15.2) of the recess (14.1, 14.2), bars (17.1, 17.2) and/or a surface texture and/or at least one lower recess (32), which is surrounded on all sides by a non-recessed area of the bottom side of the nipple flange (3), for easier detachment from the edge (29) of the mouth (30) of the bottle (1).

8. The teat according to claim 7, which has several lower recesses (32) arranged behind each other in the radial direction and/or several lower recesses (32) arranged next to each other in the circumferential direction.

9. The teat according to claim 1, in which the nipple (2) has a constriction (12) above the nipple flange (3).

10. The teat according to claim 1, in which the floor (15.1, 15.2) of the recess (14.1, 14.2) is made of a soft elastic material, wherein the entire nipple flange (3) is preferably made of soft elastic material, wherein the entire teat (1) is preferably made of soft elastic material.

11. The teat according to claim 1, which is made entirely or partially of silicone or a thermoplastic elastomer or another plastic that can be injection molded or latex and/or which is injection-molded or produced in a combined immersion-casting process.

12. The teat according to claim 1, in which the nipple flange (3) has an inner diameter of 20 to 65 mm and/or an outer diameter of 30 to 70 mm and/or a height of 0.5 to 3 mm and/or in which the recess (14.1, 14.2) in the nipple flange (3) has a depth of 0.5 to 2.5 mm and/or a length in the radial direction of the nipple flange (3) of 2 to 10 mm and/or a width in the circumferential direction of the nipple flange (3) of 5 to 15 mm and/or the floor (15.1, 15.2) a thickness of 0.5 to 1.5 mm.

13. A drinking vessel with a teat (1) according to claim 1, which is mounted on a vessel (21) by means of a fastening ring (20), wherein the fastening ring (20) has fastening means and the vessel (21) has further fastening means that are interconnected in order to fasten the teat (1) on the vessel (21), presses a ring flange (27) of the fastening ring (20) outside of the recess (14.1, 14.2) against the top side of the nipple flange (3) and presses the nipple flange (3) with the bottom side against the edge (29) of the mouth (30) of the vessel (21), wherein the recess (14.1, 14.2) is designed so that negative pressure in the vessel (21) causes the floor (15.1, 15.2) of the recess (14.1, 14.2) to arch up and air flows back into the vessel (21) from outside in the radial direction.

14. The drinking vessel according to claim 13, in which the expansion (a) of the lower recess (32) in the radial direction is less than the width (b) of the edge (29) of the mouth (30) of the vessel (21) and/or in which the distance (c) between two lower recesses (32) located consecutively in the radial direction is less than the width (b) of the edge (29) of the mouth (30) of the vessel (21).

15. The drinking vessel according to claim 13, in which the nipple flange (3) protrudes radially inwards and/or outwards over the front-side edge (29) of the mouth (30) of the vessel (21).
